(19) United States
(12) Patent Application Publication
(10) Pub. No.: US 2025/0270388 A1
(43) Pub. Date: Aug. 28, 2025

(54) CARBOXYMETHYL HEMICELLULOSE COMPOSITE FILMS AND PREPARATION METHODS THEREOF

(71) Applicant: ZHEJIANG HUAKANG PHARMACEUTICAL CO., LTD., Quzhou (CN)

(72) Inventors: Wulong YANG, Quzhou (CN); Tianying CHEN, Quzhou (CN); Mingqian YANG, Quzhou (CN); Yanjun TANG, Quzhou (CN); Mian LI, Quzhou (CN); Weidong XU, Quzhou (CN)

(73) Assignee: ZHEJIANG HUAKANG PHARMACEUTICAL CO., LTD., Quzhou (CN)

(21) Appl. No.: 19/208,656

(22) Filed: May 15, 2025

Related U.S. Application Data
(63) Continuation-in-part of application No. PCT/CN2024/088998, filed on Apr. 21, 2024.

(30) Foreign Application Priority Data
Nov. 20, 2023 (CN) 202311548566.3

(51) Int. Cl. C08L 1/28; C08J 5/18; C08K 5/053; C08K 5/13

(52) U.S. Cl. CPC C08L 1/286; C08J 5/18; C08K 5/053; C08K 5/13; C08J 2301/28; C08K 2201/014; C08L 2203/16

(57) ABSTRACT

A carboxymethyl hemicellulose composite film and a preparation method are provided. The composite film includes 95 to 100 parts by weight of carboxymethyl hemicellulose, 1 to 5 parts by weight of gallic acid, and 50 to 60 parts by weight of sorbitol. The carboxymethyl hemicellulose is obtained by an etherification reaction of bamboo hemicellulose with chloroacetic acid under an alkaline condition, and a degree of substitution of the carboxymethyl hemicellulose is within a range of 0.17 to 0.59. The preparation method includes mixing the carboxymethyl hemicellulose with deionized water, the gallic acid, and the sorbitol in sequence to obtain a composite film solution; and slowly pouring the composite film solution into a mold for drying to obtain the carboxymethyl hemicellulose composite film. The preparation method has advantages of antibacterial activity, environmental friendliness, and low cost.

### CROSS REFERENCE TO RELATED APPLICATIONS

This application is a continuation-in-part application of International Application No. PCT/CN2024/088998, filed on Apr. 21, 2024, which claims priority to Chinese Patent Application No. 202311548566.3, filed on Nov. 20, 2023, the entire contents of each of which are incorporated herein by reference.

### TECHNICAL FIELD

The present disclosure relates to the technical field of the preparation of a composite film, and in particular, to a carboxymethyl hemicellulose composite film and a preparation method thereof.

### BACKGROUND

Fruits and vegetables need to be isolated from air and microorganisms during storage and transportation to extend their shelf life. Traditional packaging films are mostly derived from non-renewable fossil resources, making the development of environmentally friendly packaging film materials with effective preservation property of great significance. Hemicellulose is abundantly available and exhibits excellent degradability and biocompatibility, making it suitable for applications in food packaging, pharmaceuticals, paper additives, etc. Phyllostachys edulis, recognized as a promising biomass resource, accounts for 72.96% of the total planted area of bamboo in China. The main components of Phyllostachys edulis are cellulose, hemicellulose, and lignin, of which hemicellulose accounts for 20% to 30%. Therefore, the separation, purification, and conversion of hemicellulose from Phyllostachys edulis into high-value products present a broad market prospect.

### SUMMARY

One of embodiments of the present disclosure provides a carboxymethyl hemicellulose composite film. The carboxymethyl hemicellulose composite film comprises 95 to 100 parts by weight of carboxymethyl hemicellulose, 1 to 5 parts by weight of gallic acid, and 50 to 60 parts by weight of sorbitol. The carboxymethyl hemicellulose is obtained by an etherification reaction of bamboo hemicellulose with chloroacetic acid under an alkaline condition, and a degree of substitution of the carboxymethyl hemicellulose is within a range of 0.17 to 0.59.

One of embodiments of the present disclosure provides a preparation method for a carboxymethyl hemicellulose composite film, comprising: step (a) mixing the carboxymethyl hemicellulose with deionized water, the gallic acid, and the sorbitol in sequence to obtain a composite film solution; and step (b) slowly pouring the composite film solution into a mold for drying to obtain the carboxymethyl hemicellulose composite film.

In some embodiments, in the step (b), before drying, the composite film solution is subjected to ultrasonic treatment for at least 10 min to remove bubbles.

In some embodiments, in the step (b), a drying condition for the carboxymethyl hemicellulose composite film is drying in a forced-air drying oven at 40° C. for 48 h.

### BRIEF DESCRIPTION OF THE DRAWINGS

FIG. 1 is a flowchart illustrating a process of a preparation method for a composite film according to some embodiments of the present disclosure;

FIG. 2 are comparison images illustrating the solubility effect of carboxymethyl hemicellulose in water according to some embodiments of the present disclosure;

FIG. 3 are images illustrating the transparency of the macroscopic morphology of composite films according to some embodiments of the present disclosure;

FIG. 4 are scanning electron microscope (SEM) images illustrating the microscopic morphology of composite films according to some embodiments of the present disclosure;

FIG. 5 is a chart illustrating the effect of the degree of substitution of carboxymethyl hemicellulose on the air permeability of composite films according to some embodiments of the present disclosure;

FIG. 6 is an image illustrating the effect of the degree of substitution of carboxymethyl hemicellulose on the antibacterial activity of composite films according to some embodiments of the present disclosure; and

FIG. 7 is a chart illustrating the effect of composite films on the weight loss rate of blueberries according to some embodiments of the present disclosure.

### DETAILED DESCRIPTION

The accompanying drawings, which are required to be used in the description of the embodiments, are briefly described below. The accompanying drawings do not represent the entirety of the embodiments.

Unless the context suggests an exception, the words “a”, “an”, “one”, “one kind”, and/or “the” do not refer specifically to the singular, but may also include the plural. Generally, the terms “including” and “comprising” suggest only the inclusion of clearly identified steps and elements that do not constitute an exclusive list, and the method may also include other steps or elements.

Hemicellulose has poor solubility in water and strong intermolecular hydrogen bonding forces, resulting in suboptimal mechanical properties for hemicellulose film materials.

The technical problem to be solved in the present disclosure is how to improve the film-forming ability and antibacterial activity of hemicellulose-based film materials, thereby enhancing their overall performance. The present disclosure provides a carboxymethyl hemicellulose composite film and a preparation method thereof. The carboxymethyl hemicellulose is prepared from bamboo hemicellulose and the carboxymethyl hemicellulose composite film is prepared based on the carboxymethyl hemicellulose, which not only exhibits antibacterial activity but also offers advantages such as environmental friendliness and low cost. The carboxymethyl hemicellulose composite film is also referred to as a composite film, or a film.

In some embodiments, the carboxymethyl hemicellulose composite film comprises 95 to 100 parts by weight of carboxymethyl hemicellulose, 1 to 5 parts by weight of gallic acid, and 50 to 60 parts by weight of sorbitol. The carboxymethyl hemicellulose may be obtained by an etherification reaction of bamboo hemicellulose with chloroacetic acid under an alkaline condition, and a degree of substitution of the carboxymethyl hemicellulose may be within a range of 0.17 to 0.59.

The carboxymethyl hemicellulose (CMH) is a hemicellulose derivative obtained by chemical modification. This chemical modification involves introduction of carboxymethyl (—CH₂COOH) groups to the hemicellulose structure, thereby endowing new functional properties. The carboxymethyl hemicellulose has excellent properties such as water solubility, thickening ability, film-forming ability, and biodegradability.

In some embodiments, the weight part of the carboxymethyl hemicellulose needs to be kept within a certain range. Specifically, if the weight part of the carboxymethyl hemicellulose is too high, it may cause the composite film to become brittle, reducing its tensile strength and toughness. Further, due to hydrophilicity of the carboxymethyl hemicellulose, an excessively high weight part of carboxymethyl hemicellulose may increase water absorption of the composite film, reducing its water resistance. Furthermore, an excessively high weight part of the carboxymethyl hemicellulose may also increase the viscosity of the solution, making the coating or film-forming process more difficult. However, if the weight part of the carboxymethyl hemicellulose is too low, the composite film may have insufficient strength, making it prone to breaking or deformation, and lead to an uneven distribution of the composite film's components, affecting its overall performance. In addition, an excessively low weight part of the carboxymethyl hemicellulose may also weaken its properties such as thickening ability, film-forming ability, and biodegradability.

In some embodiments, the weight part of the carboxymethyl hemicellulose may be 95 to 100 parts. In some embodiments, the weight part of the carboxymethyl hemicellulose may be 96 to 100 parts. In some embodiments, the weight part of the carboxymethyl hemicellulose may be 96.5 to 99 parts. In some embodiments, the weight part of the carboxymethyl hemicellulose may be 97 to 99 parts. In some embodiments, the weight part of the carboxymethyl hemicellulose may be 97.5 to 98 parts.

In some embodiments, the carboxymethyl hemicellulose is obtained by an etherification reaction of bamboo hemicellulose with chloroacetic acid under an alkaline condition.

The bamboo hemicellulose is an important polysaccharide component in the cell wall of bamboo, forming the main structure of bamboo (e.g., Phyllostachys edulis, Phyllostachys sulphurea, and Dendrocalamus asper, etc.) together with cellulose and lignin. The bamboo hemicellulose is mainly composed of a variety of monosaccharides, including xylose, arabinose, mannose, glucose, and galactose. In some embodiments, the main chain of the bamboo hemicellulose is formed by the connection of xylose or mannose through β-1,4-glycosidic bonds, while the side chains contain monosaccharides such as arabinose and galactose. In some embodiments, the bamboo hemicellulose may be extracted through processes of raw material pretreatment, delignification, hemicellulose extraction, and purification.

The bamboo hemicellulose may be degraded by microorganisms or enzymes, making it an environmentally friendly material. The bamboo hemicellulose contains a large number of hydroxyl groups (—OH), making it susceptible to chemical modification such as etherification, esterification, and crosslinking. Through chemical modification, the water solubility, mechanical properties, and other characteristics of the bamboo hemicellulose may be adjusted.

The ctherification reaction of the bamboo hemicellulose with the chloroacetic acid under the alkaline condition refers to the introduction of carboxymethyl (—CH₂COOH) groups onto the hydroxyl groups (—OH) in the bamboo hemicellulose molecules. A preparation process of the carboxymethyl hemicellulose may include an alkalization reaction and an etherification reaction.

The alkalization reaction refers to the process where the deprotonation of the hydroxyl groups (—OH) of the bamboo hemicellulose (denoted as Hemicellulose) are deprotonated in an alkaline (e.g., NaOH) solution to form alkoxide ions (—O⁻), as shown in reaction formula (1).

Hemicellulose-OH+NaOH→Hemicellulose-O—Na++H₂O (1).

The etherification reaction refers to the process where alkalized hemicellulose reacts with the chloroacetic acid (ClCH₂COOH). During the reaction, the alkoxide (—O⁻) attacks the carbon atom of the chloroacetic acid to replace the chlorine atom, forming the carboxymethyl hemicellulose, as shown in reaction formula (2).

Hemicellulose-O—Na++ClCH₂COOH→Hemicellulose-O—CH₂COOH+NaCl (2).

Due to the poor solubility of the bamboo hemicellulose in water and the strong intermolecular hydrogen bonding force, the mechanical properties of hemicellulose film materials are relatively weak.

Due to the low solubility of hemicellulose in water, its film-forming ability is poor. Therefore, carboxymethylation modification of hemicellulose can improve the solubility of the carboxymethyl hemicellulose in water and enhance the biological activity of the composite film. Carboxymethylation modification of hemicellulose extracted from Phyllostachys edulis results in the carboxymethylation of the hydroxyl groups on the hemicellulose molecular chains, which effectively improves the physicochemical properties of hemicellulose and enhances its biological activity. The carboxymethyl hemicellulose carries a negative charge, allowing it to adsorb onto the surface of cells. While preventing bacteria from absorbing nutrients, it also disrupts bacterial physiological activities, hindering bacterial reproduction.

The degree of substitution (DS) of the carboxymethyl hemicellulose refers to an index reflecting the extent of the hydroxyl group substitution by carboxymethyl groups in the bamboo hemicellulose molecules. The higher the degree of substitution of the carboxymethyl hemicellulose, the greater the extent of the hydroxyl group substitution by carboxymethyl groups in the bamboo hemicellulose molecules. Conversely, the lower the degree of substitution, the smaller the extent of hydroxyl group substitution by carboxymethyl groups in the bamboo hemicellulose molecules.

In some embodiments, the degree of substitution of the carboxymethyl hemicellulose needs to be kept within a certain range. If the degree of substitution of the carboxymethyl hemicellulose is too high, it may result in excessive carboxymethyl groups in the carboxymethyl hemicellulose molecules, which may lead to an excessively high crosslinking density between molecular chains, thereby reducing the flexibility of the composite film, increasing brittleness, and making it more prone to rupture under stress. Further, if the degree of substitution of the carboxymethyl hemicellulose is too high, it may also result in excessive hydrophilicity. In high-humidity environments, the composite film may absorb too much water, leading to a decrease in mechanical properties or deformation. However, if the degree of substitution of the carboxymethyl hemicellulose is too low, it may result in fewer carboxymethyl groups being introduced into the carboxymethyl hemicellulose molecules, leading to insufficient hydrophilicity. As a result, the water solubility of the carboxymethyl hemicellulose is poor, making it difficult to form a uniform composite film solution in water, which further affects the film-forming ability. Further, if the degree of substitution of the carboxymethyl hemicellulose is too low, it may also result in weaker interactions between the carboxymethyl hemicellulose molecule chains, making it difficult to form a stable network structure.

In some embodiments, the degree of substitution of the carboxymethyl hemicellulose may be within a range of 0.17 to 0.59. In some embodiments, the degree of substitution of the carboxymethyl hemicellulose may be within a range of 0.19 to 0.55. In some embodiments, the degree of substitution of the carboxymethyl hemicellulose may be within a range of 0.25 to 0.50. In some embodiments, the degree of substitution of the carboxymethyl hemicellulose may be within a range of 0.28 to 0.42. In some embodiments, the degree of substitution of the carboxymethyl hemicellulose may be within a range of 0.33 to 0.37.

The gallic acid, also known as 3,4,5-trihydroxybenzoic acid, is a naturally occurring polyphenolic organic compound widely distributed in plants such as gallnuts, tea leaves, and oak bark. The gallic acid, as an antibacterial agent, can inhibit the synthesis of polysaccharides on bacterial biofilms, thus hindering bacterial growth and achieving antibacterial effects.

In some embodiments, the weight part of the gallic acid needs to be kept within a certain range. If the weight part of the gallic acid is too high, it may cause a decrease in the transparency of the composite film, leading to cloudiness or unevenness. Further, since the gallic acid can form hydrogen bonds or cross-linked structures with the carboxymethyl hemicellulose, if the weight part of the gallic acid is too high, excessive gallic acid may lead to a high cross-linking density in the composite film, making the film brittle and reducing its flexibility and ductility. However, if the weight part of the gallic acid is too low, it may reduce the inhibitory ability of the composite film to bacteria and fungi. Further, since the gallic acid has certain antioxidant properties, if the weight part of gallic acid is too low, it may result in insufficient antioxidant capacity in the composite film, making it unable to effectively inhibit oxidation reaction. In addition, since the gallic acid can form hydrogen bonds or cross-linked structures with the carboxymethyl hemicellulose, if the weight part of the gallic acid is too low, it may reduce the mechanical properties of the composite film.

In some embodiments, the weight part of the gallic acid may be 1 to 5 parts. In some embodiments, the weight part of the gallic acid may be 1.5 to 4.8 parts. In some embodiments, the weight part of the gallic acid may be 1.5 to 4.5 parts. In some embodiments, the weight part of the gallic acid may be 2 to 4 parts. In some embodiments, the weight part of the gallic acid is 2.6 to 3.3 parts. In some embodiments, the weight part of the gallic acid may be 2.8 to 3 parts.

The sorbitol is a naturally occurring sugar alcohol widely used in food, medicine, cosmetics, and chemicals. One the one hand, the sorbitol, as a functional sugar alcohol, is a food-grade plasticizer, which can improve film-forming ability. On the other hand, the sorbitol, as a food-grade antibacterial agent, can effectively inhibit bacterial reproduction.

In some embodiments, the weight part of the sorbitol needs to be kept within a certain range. If the weight part of the sorbitol is too high, it may cause the film to become excessively soft and even exhibit stickiness, making it difficult to peel off or prone to sticking, affecting its performance. However, since the main role of the sorbitol is as a plasticizer, if the weight part of the sorbitol is too low, it may reduce the interactions between the carboxymethyl cellulose molecular chains, resulting in insufficient plasticization. As a result, the film may exhibit higher brittleness and be more prone to cracking.

In some embodiments, the weight part of the sorbitol may be 50 to 60 parts. In some embodiments, the weight part of the sorbitol may be 51 to 58 parts. In some embodiments, the weight part of the sorbitol may be 52 to 57 parts. In some embodiments, the weight part of the sorbitol may be 52.5 to 56 parts. In some embodiments, the weight part of the sorbitol may be 53 to 55 parts. In some embodiments, the weight part of the sorbitol may be 53.5 to 54.1 parts.

In some embodiments of the present disclosure, the carboxymethyl hemicellulose is obtained by chemically modifying hemicellulose, and a composite film is prepared by mixing the carboxymethyl hemicellulose, the sorbitol, and the gallic acid. By coordinating the properties of these three components and fully utilizing their respective advantages, the obtained composite film not only exhibits good film-forming ability but also possesses antibacterial activity, with overall excellent performance.

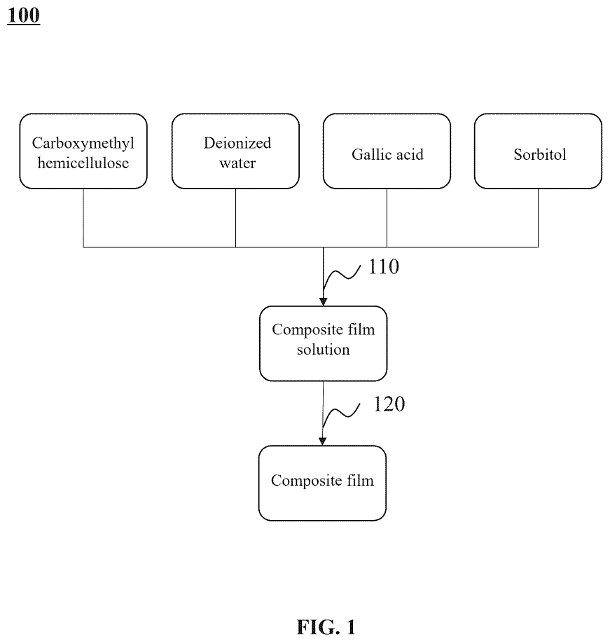

FIG. 1 is a flowchart illustrating a process of a preparation method for a carboxymethyl hemicellulose composite film according to some embodiments of the present disclosure. As shown in FIG. 1, a process 100 may include following steps.
In step 110, carboxymethyl hemicellulose may be mixed with deionized water, gallic acid, and sorbitol in sequence to obtain a composite film solution.

The composite film solution refers to a solution for preparing a carboxymethyl hemicellulose composite film. The composite film solution may be prepared by mixing the carboxymethyl hemicellulose, the deionized water, and the gallic acid, and the sorbitol.

In some embodiments, the carboxymethyl hemicellulose, the deionized water, the gallic acid, and the sorbitol may be added in sequence to a beaker and stirred at a preset stirring temperature and a preset rotational speed for a preset stirring duration to obtain the composite film solution.

If the preset stirring temperature is too high, it may lead to the degradation of the carboxymethyl hemicellulose, reducing its molecular weight and properties; the gallic acid may undergo oxidization, reducing its antibacterial activity; the sorbitol may decompose, affecting its plasticizing effect; and the solution may volatize, affecting the film-forming ability. However, since the dissolution of the carboxymethyl hemicellulose, the gallic acid, and the sorbitol slows down at low temperature, if the preset stirring temperature is too low, it may lead to uneven mixing. In some embodiments, the preset stirring temperature may be within a range of 40° C. to 60° C. In some embodiments, the preset stirring temperature may be within a range of 41° C. to 59° C. In some embodiments, the preset stirring temperature may be within a range of 41° C. to 58° C. In some embodiments, the preset stirring temperature may be within a range of 46° C. to 53.5° C. In some embodiments, the preset stirring temperature may be within a range of 48° C. to 51° C. In some embodiments, the preset stirring temperature may be 50° C.

If the preset rotational speed is too large, air may be drawn into the composite film solution to form bubbles, affecting the uniformity and transparency of the composite film. However, if the preset rotational speed is too small, it is difficult to fully mix the carboxymethyl hemicellulose, the gallic acid, and the sorbitol, resulting in an uneven composite film solution and lower production efficiency. In some embodiments, the preset rotational speed may be within a range of 450 r/min to 600 r/min. In some embodiments, the preset rotational speed may be within a range of 455 r/min to 580 r/min. In some embodiments, the preset rotational speed may be within a range of 460 r/min to 560 r/min. In some embodiments, the preset rotational speed may be within a range of 467 r/min to 545 r/min. In some embodiments, the preset rotational speed may be within a range of 480 r/min to 520 r/min. In some embodiments, the preset rotational speed may be within a range of 490 r/min to 515 r/min. In some embodiments, the preset rotational speed may be 500 r/min.

If the preset stirring duration is too long, it may increase energy consumption and reduce production efficiency. If the preset stirring duration is too short, it may result in insufficient dissolution and mixing of the carboxymethyl hemicellulose, the gallic acid, and the sorbitol, which affects the uniformity of the composite film solution, thereby affecting the performance of the composite film. In some embodiments, the preset stirring duration may be within a range of 0.5 h to 3 h. In some embodiments, the preset stirring duration may be within a range of 0.8 h to 2.8 h. In some embodiments, the preset stirring duration may be within a range of 0.9 h to 2.7 h. In some embodiments, the preset stirring duration may be within a range of 1.3 h to 2.4 h. In some embodiments, the preset stirring duration may be within a range of 1.5 h to 2.3 h. In some embodiments, the preset stirring duration may be within a range of 1.8 h to 2.2 h. In some embodiments, the preset stirring duration may be 2 h.

In step 120, the composite film solution may be slowly poured into a mold for drying to obtain a composite film.

In some embodiments, the size of the mold may be set as desired. In some embodiments, the shape of the mold may be rectangular, square, triangular, circular, or the like, which may be set according to the demand. In some embodiments, the material of the mold may be silicone, glass, stainless steel, polypropylene, or the like. In some embodiments, the mold is a silicone mold of 3.5 cm×3.5 cm.

In some embodiments, before drying to form a film, the composite film solution is subjected to ultrasonic treatment for a preset ultrasonic duration to remove bubbles. The preset ultrasonic duration may not be too short. If the preset ultrasonic duration is too short, it may not effectively remove bubbles.

In some embodiments, the preset ultrasonic duration may be greater than 6 min. In some embodiments, the preset ultrasonic duration may be greater than 8 min. In some embodiments, the preset ultrasonic duration may be greater than 10 min. In some embodiments, the preset ultrasonic duration may be greater than 12 min. In some embodiments, the preset ultrasonic duration may be greater than 15 min.

Removing bubbles through ultrasonic treatment is a technique using the cavitation effect and mechanical vibrations of ultrasound waves to eliminate bubbles in liquids. Specifically, the cavitation effect of ultrasound waves causes large bubbles in the liquid to break into smaller bubbles and these smaller bubbles are more easily dissolved into the liquid or expelled. The cavitation effect also increases the contact area between the bubbles and the surrounding liquid, accelerating the dissolution of the bubbles. Further, the high-frequency vibrations of ultrasound waves cause small bubbles in the liquid to collide and merge into larger bubbles and these larger bubbles quickly rise to the surface of the liquid and rupture due to high buoyancy. Furthermore, the high-frequency vibrations of ultrasound waves generate a microfluidic flow within the liquid, driving the bubbles toward the surface and the bubbles rupture and release the gas into the air once reaching the surface.

In some embodiments, the bubbles may also be removed by other means such as vacuum degassing, static degassing, or the like.

In some embodiments of the present disclosure, the bubbles are removed through the ultrasonic treatment, which can improve the uniformity, transparency, and mechanical properties of the composite film, and prevent bubbles remaining in the composite film solution from forming voids or defects in the film-forming process, thereby avoiding issues such as uneven thickness, pits, cracks, and other defects in the composite film.

In some embodiments, a drying condition for the composite film may be drying in a forced-air drying oven at a preset drying temperature for a preset drying duration.

If the preset drying temperature is too high, it may cause rapid evaporation of the deionized water, resulting in concentrated internal stress within the composite film, which could lead to deformation, cracking, or curling of the composite film, as well as surface defects such as bubbles, pits, or cracks. Additionally, the too high preset drying temperature may damage the structure of the carboxymethyl hemicellulose, the gallic acid, and the sorbitol, thereby reducing the mechanical properties, antibacterial performance, plasticizing effect, and other characteristics of the composite film. However, if the preset drying temperature is too low, it may result in insufficient rearrangement of the molecular chains, causing the composite film to have a loose structure and poor mechanical properties. Additionally, the too low preset drying temperature may lead to the slow evaporation of the deionized water, prolonging the drying time and reducing production efficiency. In some embodiments, the preset drying temperature may be within a range of 35° C. to 50° C. In some embodiments, the preset drying temperature may be within a range of 36° C. to 48° C. In some embodiments, the preset drying temperature may be within a range of 37° C. to 45° C. In some embodiments, the preset drying temperature may be within a range of 38° C. to 44° C. In some embodiments, the preset drying temperature may be within a range of 39° C. to 42° C. In some embodiments, the preset drying temperature may be 40° C.

If the preset drying duration is too long, it may cause the composite film to be exposed to high temperature for a long time, causing material aging or performance degradation. Additionally, the too long preset drying duration may increase energy consumption and reduce production efficiency. However, if the preset drying temperature is too short, the deionized water may not be fully evaporated, leaving residual moisture in the composite film, which could negatively impact its performance. In some embodiments, the preset drying duration may be within a range of 35 h to 55 h. In some embodiments, the preset drying duration may be within a range of 37 h to 54 h. In some embodiments, the preset drying duration may be within a range of 38 h to 53 h. In some embodiments, the preset drying duration may be within a range of 42 h to 52 h. In some embodiments, the preset drying duration may be within a range of 44 h to 50 h. In some embodiments, the preset drying duration may be within a range of 45 h to 49 h. In some embodiments, the preset drying duration may be 48 h.

In some embodiments of the present disclosure, a high-quality and high-performance composite film may be prepared by drying the composite film in the forced-air drying oven at 40° C. for 48 h.

In some embodiments of the present disclosure, the operation process is simple and the preparation time is short, which can effectively address the issue of the poor film-forming ability of hemicellulose, improve the dispersion between the carboxymethyl hemicellulose, the sorbitol, and the gallic acid, and significantly enhance the antibacterial activity of the composite film.

It should be noted that the foregoing description of the preparation method for the carboxymethyl hemicellulose composite film is for the purpose of exemplary and illustrative purposes only and does not limit the scope of application of the present disclosure. For a person skilled in the art, various modifications and alterations may be made to the preparation method for the carboxymethyl hemicellulose composite film under the guidance of the present disclosure. However, these corrections and changes remain within the scope of the present disclosure.

The preparation method for the carboxymethyl hemicellulose composite film is described in detail below by way of examples. It is noted that the reaction conditions, the reaction materials, and the amount of the reaction materials, etc., in the examples are only intended to illustrate the preparation method for the carboxymethyl hemicellulose composite film, and do not limit the scope of protection of the present disclosure.

### EXAMPLE 1

A first example of a preparation method for a carboxymethyl hemicellulose composite film was provided, the method comprising following steps.
In step 111: a hemicellulose-based composite film solution was prepared. 0.35 g of carboxymethyl hemicellulose with a degree of substitution of 0.17, 12.5 g of deionized water, 0.7 mL of gallic acid at a concentration of 0.037 g/mL, and 0.2 g of sorbitol were sequentially added to a 50 mL beaker and stirred at 50° C. and 500 r/min for 2 h to obtain a composite film solution.
In step 121: a hemicellulose-based composite film was prepared. The composite film solution was subjected to ultrasonic treatment for 10 min to remove bubbles, then the composite film solution was slowly poured into a silicon mold of 3.5 cm×3.5 cm and dried in a forced-air drying oven at 40° C. for 48 h to obtain a carboxymethyl hemicellulose composite film.

### EXAMPLE 2

A second example of a preparation method for a carboxymethyl hemicellulose composite film was provided, the method comprising following steps.
In step 112: a hemicellulose-based composite film solution was prepared. 0.35 g of carboxymethyl hemicellulose with a degree of substitution of 0.33, 12.5 g of deionized water, 0.7 mL of gallic acid at a concentration of 0.037 g/mL, and 0.2 g of sorbitol were sequentially added to a 50 mL beaker and stirred at 50° C. and 500 r/min for 2 h to obtain a composite film solution.
In step 122: a hemicellulose-based composite film was prepared. The composite film solution was subjected to ultrasonic treatment for 10 min to remove bubbles, then the composite film solution was slowly poured into a silicon mold of 3.5 cm×3.5 cm and dried in a forced-air drying oven at 40° C. for 48 h to obtain a carboxymethyl hemicellulose composite film.

### EXAMPLE 3

A third example of a preparation method for a carboxymethyl hemicellulose composite film is provided, the method comprising following steps.
In step 113: a hemicellulose-based composite film solution was prepared. 0.35 g of carboxymethyl hemicellulose with a degree of substitution of 0.46, 12.5 g of deionized water, 0.7 mL of gallic acid at a concentration of 0.037 g/mL, and 0.2 g of sorbitol were sequentially added to a 50 mL beaker and stirred at 50° C. and 500 r/min for 2 h to obtain a composite film solution.
In step 123: a hemicellulose-based composite film was prepared. The composite film solution was subjected to ultrasonic treatment for 10 min to remove bubbles, then the film solution was slowly poured into a silicon mold of 3.5 cm×3.5 cm and dried in a forced-air drying oven at 40° C. for 48 h to obtain a carboxymethyl hemicellulose composite film.

### EXAMPLE 4

A fourth example of a preparation method for a carboxymethyl hemicellulose composite film is provided, the method comprising following steps.
In step 114: a hemicellulose-based composite film solution was prepared. 0.35 g of carboxymethyl hemicellulose with a degree of substitution of 0.59, 12.5 g of deionized water, 0.7 mL of gallic acid at a concentration of 0.037 g/mL, and 0.2 g of sorbitol were sequentially added to a 50 mL beaker and stirred at 50° C. and 500 r/min for 2 h to obtain a composite film solution.

In step 124: a hemicellulose-based composite film was prepared. The composite film solution was subjected to ultrasonic treatment for 10 min to remove bubbles, then the film composite solution was slowly poured into a silicon mold of 3.5 cm×3.5 cm and dried in a forced-air drying oven at 40° C. for 48 h to obtain a carboxymethyl hemicellulose composite film.

### Comparison Example 1

The first comparison example of the present disclosure comprised following steps.
In step 115: a hemicellulose-based composite film solution was prepared. 0.35 g of hemicellulose, 12.5 g of deionized water, 0.7 mL of gallic acid at a concentration of 0.037 g/mL, and 0.2 g of sorbitol were sequentially added to a 50 mL beaker and stirred at 50° C. and 500 r/min for 2 h to obtain a composite film solution.

In step 125: a hemicellulose-based composite film was prepared. The composite film solution was subjected to ultrasonic treatment for 10 min to remove bubbles, then the film solution was slowly poured into a silicon mold of 3.5 cm×3.5 cm and dried in a forced-air drying oven at 40° C. for 48 h to obtain a composite film.

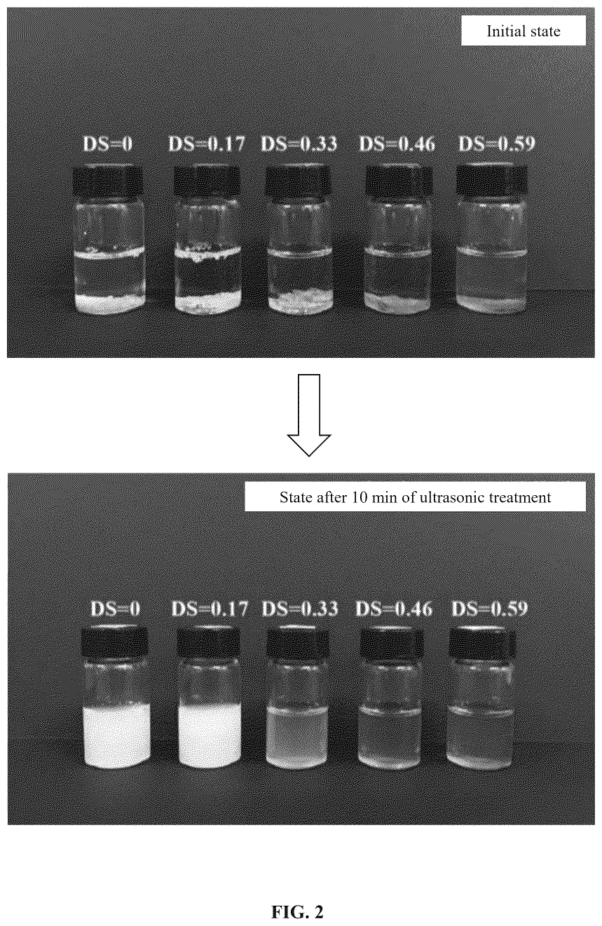

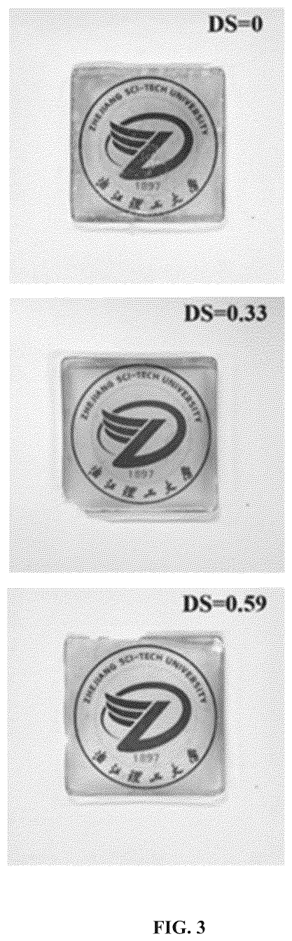

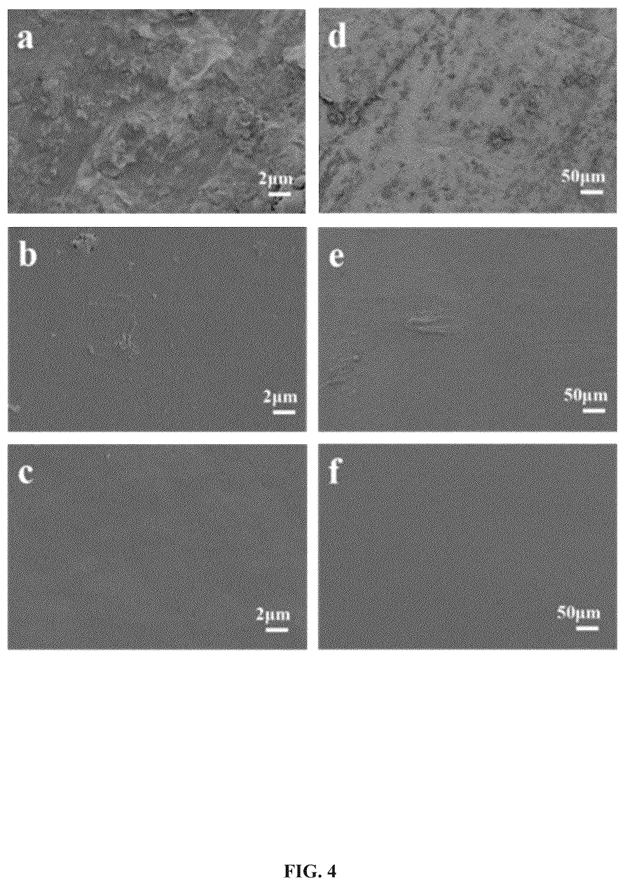

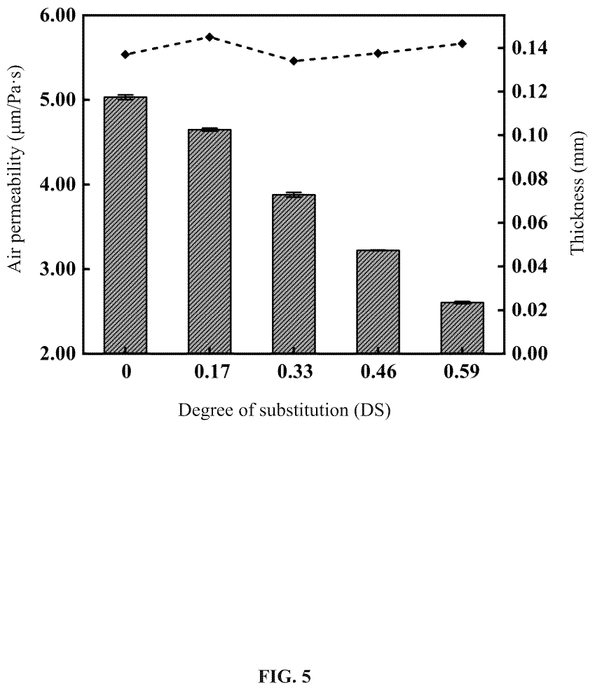

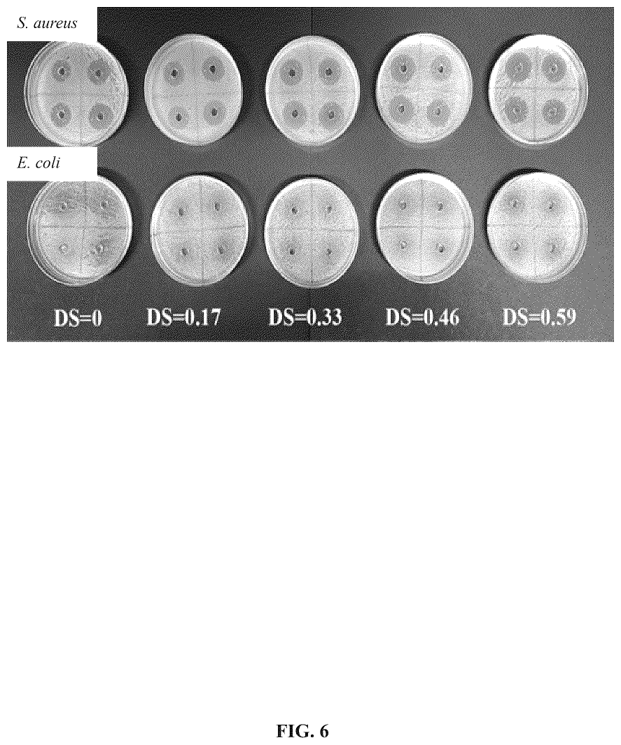

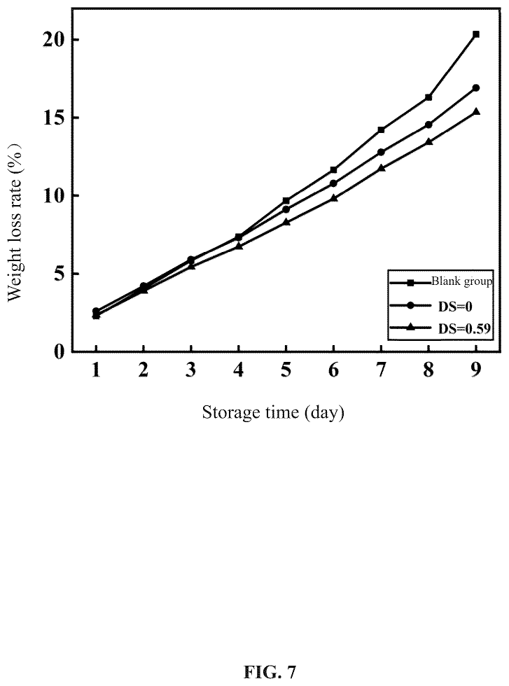

FIG. 2 are comparison images illustrating the solubility effect of carboxymethyl hemicellulose in water according to some embodiments of the present disclosure. FIG. 3 are images illustrating the transparency of the macroscopic morphology of composite films according to some embodiments of the present disclosure. FIG. 4 are scanning electron microscope (SEM) images illustrating the microscopic morphology of composite films according to some embodiments of the present disclosure. FIG. 5 is a chart illustrating the effect of the degree of substitution of carboxymethyl hemicellulose on the air permeability of composite films according to some embodiments of the present disclosure. FIG. 6 is an image illustrating the effect of the degree of substitution of carboxymethyl hemicellulose on the antibacterial activity of composite films according to some embodiments of the present disclosure. FIG. 7 is a chart illustrating the effect of composite films on the weight loss rate of blueberries according to some embodiments of the present disclosure.

In comparison example 1 and examples 1 to 4, the carboxymethyl hemicellulose has DS of 0, 0.17, 0.33, 0.46, and 0.59, respectively. A supplementary explanation for the figures is provided in conjunction with comparison example 1 and examples 1 to 4.

In FIG. 2, the composite film solutions containing carboxymethyl hemicellulose with different DS (0, 0.17, 0.33, 0.46, and 0.59) are presented at an initial state and a state after 10 min of ultrasonic treatment, which corresponds to the composite film solutions prepared in comparison example and examples 1 to 4. The solubility of bamboo hemicellulose (DS=0) in water is poor, and the bamboo hemicellulose solution is turbid after 10 min of the ultrasonic treatment, indicating that more bamboo hemicellulose remains undissolved. With the increase of the degree of carboxymethylation modification of the bamboo hemicellulose, the solubility of the modified bamboo hemicellulose in water is gradually improved. When the DS of the carboxymethyl hemicellulose is 0.33, the composite film solution is only slightly turbid after 10 min of the ultrasonic treatment, indicating that the carboxymethyl hemicellulose is mostly dissolved in water. When the DS of the carboxymethyl hemicellulose is within a range of 0.46 to 0.59, the carboxymethyl hemicellulose is completely dissolved in water, and the composite film solution is clarified and transparent, and there is no obvious precipitation at the bottom of the bottle, indicating that the solubility of carboxymethyl hemicellulose in water is significantly improved after carboxymethylation modification.

In FIG. 3, the composite films containing carboxymethyl hemicellulose with different DS (0, 0.33, and 0.59) are presented, and the composite films are prepared in comparison example 1, example 2, and example 4. The composite film prepared by adding bamboo hemicellulose (DS=0) has an uneven surface and low transparency. When using hemicellulose by carboxymethylation modification (DS=0.33 or DS=0.59) to prepare the composite film, the composite film has a smooth and flat surface and high transparency, and the surface flatness and transparency of the composite film improve significantly as the DS of carboxymethyl hemicellulose increases, which results from the fact that the hydrophilicity of the bamboo hemicellulose by the carboxymethylation modification is significantly increased.

In FIG. 4, SEM images of a composite film containing bamboo hemicellulose (DS=0) are shown in images a and d, which corresponds to the SEM images of a composite film prepared in comparison example 1. As can be seen from the images a and d, the surface of the composite film is rough, which results from the fact that before modification, the bamboo hemicellulose is slightly soluble in water and has poor dispersibility and film-forming ability. SEM images of a composite film containing carboxymethyl hemicellulose (DS=0.33) are shown in images b and e, which corresponds to the SEM images of a composite film prepared in example 2. As can be seen from the images b and e, the roughness of the surface of the composite film is reduced. SEM images of a composite film containing carboxymethyl hemicellulose (DS=0.59) are shown in images c and f, which corresponds to the SEM images of a composite film prepared in example 4. As can be seen from the images c and f, the roughness of the surface of the composite film is further reduced, indicating that the surface of the composite film is flatter and smoother as the DS of carboxymethyl hemicellulose increases.

In FIG. 5, a schematic diagram of thickness test comparison and air permeability test comparison is shown for composite films containing carboxymethyl hemicellulose with different DS (0, 0.17, 0.33, 0.46, and 0.59), and the composite films are prepared in comparison example 1 and examples 1 to 4. As can be seen from the FIG. 4, the DS of carboxymethyl hemicellulose has no significant effect on the thickness of the composite films, and the thickness of the composite films is all around 0.14 mm. When using bamboo hemicellulose (DS=0) to obtain the composite film, the air permeability of the composite film is 5.03 μm/Pa·s. As the increase of the DS of carboxymethyl hemicellulose increases, the air permeability of the composite film decreases significantly. When using carboxymethyl hemicellulose with the DS of 0.59 to obtain the composite film, the air permeability of the composite film is 2.60 μm/Pa·s, with a decrease of 48.31% in air permeability. Therefore, it is suggested that the air barrier performance of the composite film is significantly improved with the DS increases.

In FIG. 6, comparison images of antibacterial tests of composite films containing carboxymethyl hemicellulose with different DS (0, 0.17, 0.33, 0.46, and 0.59) against S. aureus (gram-positive bacteria) and E. coli (gram-negative bacteria) are presented, and the composite films are prepared in comparative example 1 and examples 1 to 4, respectively. The composite films containing carboxymethyl hemicellulose with different DS exhibit antibacterial activity against S. aureus, and distinct inhibition zones form around the composite films. Sorbitol, as a food-grade antibacterial agent, can effectively inhibit bacterial reproduction. Gallic acid can also inhibit the synthesis of polysaccharides on bacterial biofilms, thus hindering bacterial growth. When the DS of carboxymethyl hemicellulose increases, the diameter of the inhibition zone around the composite film increases, indicating that the antibacterial effect of the composite film is better against S. aureus as the DS of carboxymethyl hemicellulose increases. However, the composite films have no obvious inhibitory effect on E. coli. Comprehensively, the carboxymethyl hemicellulose/sorbitol/gallic acid composite film exhibit certain antibacterial activity, and the inhibitory effect on gram-positive bacteria is better than that on Gram-negative bacteria.

In FIG. 6, the diameter of the inhibition zones of carboxymethyl hemicellulose composite films with different DS is shown in Table 1.

TABLE 1
Diameter of inhibition zones of carboxymethyl
hemicellulose composite films with different DS

| | S. aureus-diameter of inhibition | E. coli-diameter of |
|---|---|---|
| DS | zone (mm) | inhibition zone (mm) |
| 0 | 24 ± 2 | 0 |
| 0.17 | 24 ± 2 | 0 |
| 0.33 | 26 ± 2 | 0 |
| 0.46 | 27 ± 2 | 0 |
| 0.59 | 27 ± 2 | 0 |

In FIG. 7, a comparison test curve of weight loss rate of blueberries in coating groups and a blank group, the blueberries in the coating groups are coated using composite films containing carboxymethyl hemicellulose with DS of 0 and 0.59 as cling films, and the blueberries in the blank group are not coated with cling film. The weight loss rate of blueberries in the coating groups is all significantly improved compared with blueberries in the blank group. During the first four days of storage, there is a slight difference in weight loss rate of blueberries between the blank group and the coating groups (DS=0 and 0.59). On day 5, the weight loss rate of blueberries in the blank group is 9.67%, while the weight loss rates of blueberries in the coating groups are 9.11% (DS=0) and 8.27% (DS=0.59), which are lower than that of blueberries in the blank group. As the storage time increases, the difference in weight loss rates of blueberries between the blank group and the coating groups (DS-0 and 0.59) become more significant. On day 9, the weight loss rate of blueberries in the blank group is 20.34%, while the weight loss rate of blueberries in the coating group is 16.90% (DS=0) and 15.36% (DS=0.59), which is significantly lower than that of blueberries in the blank group, indicating that the composite films has a certain effect on the preservation of blueberries, and the preservation effect of the carboxymethyl hemicellulose composite films is better than that of the unmodified hemicellulose composite film.

In FIG. 7, the preservation effect of blueberries in the coating groups and the blank group is recorded in Table 2:

TABLE 2
Preservation effect of blueberries in coating groups and blank group

| group | day 0 | day 1 | day 5 | day 9 |
|---|---|---|---|---|
| blank | fresh | fresh | bright, diminished gloss, | dull fruit surface, glossy-free, |
| group | | | slight soft, natural fruit | soft and flaccid texture, faint |
| | | | aroma, fresh pleasant scent, | natural fruity aroma, small |
| | | | no signs of decay | decay spots |
| coating | fresh | fresh | bright and glossy, moderate | bright, diminished gloss, |
| group | | | firmness, intense natural | slight soft, natural fruit |
| (DS = 0) | | | fruity aroma, no signs of | aroma, fresh pleasant scent, |
| | | | decay | no signs of decay |
| film-coated | fresh | fresh | bright and glossy, moderate | bright and glossy, moderate |
| group | | | firmness, intense natural | firmness, intense natural fruit |
| (DS = 0.59) | | | fruity aroma, no signs of | aroma, no signs of decay |
| | | | decay | |

Beneficial effects of embodiments of the present disclosure include but are not limited to: (1) the composite films have good air barrier property and an excellent preservation effect on fruits. (2) The preparation process is simple, with a short experimental cycle, and the used raw materials are derived from nature and are renewable resources. Therefore, the prepared composite films are biodegradable materials, which can be widely applied in various bio-functional materials and packaging materials. (3) The carboxymethyl hemicellulose is obtained through the chemical modification of hemicellulose, and the composite film is obtained by mixing carboxymethyl hemicellulose with the sorbitol and the gallic acid, which can optimally balance the properties of the three components and fully utilize their advantages, so as to the composite films with excellent film-forming ability, antibacterial activity, and comprehensive performance. (4) By performing the ultrasonic treatment to remove bubbles, the uniformity, transparency, and mechanical properties of the obtained composite film can be improved, which prevents residual bubbles in the composite film solution from forming voids or defects during film formation, thereby avoiding issues such as uneven thickness, pits, and cracks in the final composite film. (5) By drying in a forced-air drying oven at 40° C. for 48 h, high-quality and high-performance composite films can be prepared.

When describing the operations performed in the embodiments of the present disclosure in terms of the steps, the order of the steps is all interchangeable, the steps may be omitted, and other steps may be included in the course of the operations, if not otherwise specified.

The embodiments in the present disclosure are for the purpose of exemplification and illustration only and do not limit the scope of application of the present disclosure. For a person skilled in the art, various corrections and changes that may be made under the guidance of the present disclosure are still within the scope of the present disclosure.

Some features, structures, or characteristics of one or more embodiments of the present disclosure may be suitably combined.

Some embodiments use numbers describing the number of components and attributes, and it is to be understood that such numbers used in the description of embodiments are modified in some examples by the modifiers “about”, “approximately”, or “substantially”. Unless otherwise noted, the terms “about,” “approximately,” or “substantially” indicates that a ±20% variation in the stated number is allowed. Correspondingly, in some embodiments, the numerical parameters used in the present disclosure and claims are approximations, which approximations are subject to change depending on the desired characteristics of individual embodiments. While the numerical domains and parameters used in some embodiments of the present disclosure to confirm the breadth of their ranges are approximations, in specific embodiments, such values are set as precisely as possible within a feasible range.

In the event of any inconsistency or conflict between the descriptions, definitions, and/or the use of terms in the materials cited in the present disclosure and those described in the present disclosure, the descriptions, definitions, and/or the use of terms in the present disclosure shall prevail.

What is claimed is:

1. A carboxymethyl hemicellulose composite film, comprising 95 to 100 parts by weight of carboxymethyl hemicellulose, 1 to 5 parts by weight of gallic acid, and 50 to 60 parts by weight of sorbitol, wherein the carboxymethyl hemicellulose is obtained by an etherification reaction of bamboo hemicellulose with chloroacetic acid under an alkaline condition, and a degree of substitution of the carboxymethyl hemicellulose is within a range of 0.17 to 0.59.

2. A preparation method for the carboxymethyl hemicellulose composite film of claim 1, comprising:
step (a) mixing the carboxymethyl hemicellulose with deionized water, the gallic acid, and the sorbitol in sequence to obtain a composite film solution; and
step (b) slowly pouring the composite film solution into a mold for drying to obtain the carboxymethyl hemicellulose composite film.

3. The preparation method of claim 2, wherein in the step (b), before drying, the composite film solution is subjected to ultrasonic treatment for at least 10 min to remove bubbles.

4. The preparation method of claim 2, wherein in the step (b), a drying condition for the carboxymethyl hemicellulose composite film is drying in a forced-air drying oven at 40° C. for 48 h.
